(19) United States
(12) Patent Application Publication
(10) Pub. No.: US 2012/0229528 A1
(43) Pub. Date: Sep. 13, 2012

(54) LUMINANCE CONTROL FOR PIXELS OF A DISPLAY PANEL

(75) Inventor: Erno Hermanus Antonius Langendijk, Eindhoven (NL)

(73) Assignee: KONINKLIJKE PHILIPS ELECTRONICS N.V., EINDHOVEN (NL)

(21) Appl. No.: 13/498,614

(22) PCT Filed: Nov. 25, 2010
(86) PCT No.: PCT/IB10/55425

§ 371 Date: Mar. 28, 2012

(30) Foreign Application Priority Data
Dec. 2, 2009 (EP) 09177703.7

(51) Int. Cl. G09G 5/10

(52) U.S. Cl. 345/690

(57) ABSTRACT

A display panel control apparatus receives an image to be displayed by a display panel (103) in at least a first field and a second field. A first driver (107) generates a first drive signal for a pixel for the first field in response to an image pixel value and a second driver (109) generates a second drive signal for the pixel for the second field in response to the image value. The first and second drive levels correspond to first and second radiated luminance levels respectively from the pixel. The first and second radiated luminance levels are different and have a combined radiated luminance corresponding to the luminance level for the pixel. The first and second drive signals are selected from a first and second set of quantized values which are arranged to provide more discrete values of the combined radiated luminance than are included in the first and second sets.

### FIELD OF THE INVENTION

The invention relates to a luminance control for pixels of a display panel and in particular, but not exclusively to control of the luminance level for an individual colour channel of a colour display panel.

### BACKGROUND OF THE INVENTION

Digital displays such as Liquid Crystal Displays (LCD), Organic Light Emitting Diode (OLED) displays, and plasma displays have become increasingly popular and have almost exclusively replaced the traditional Cathode Ray Tube (CRT) displays.

However, a characteristic of such systems is that the driving circuits for the display panels tend to be limited to a quantization degree that is in many cases lower than the quantization of the image data for the image to be presented.

For example, a typical LCD display usually provides 8 bits per colour channel (i.e. 8 bits for each of the Red, Green and Blue colour channels). Such a display can provide a luminance distribution for each colour channel which is quantized into 2⁸=256 discrete luminance levels. However, image data is increasingly provided with quantization resolutions that are substantially higher than this. For example, image data with 12, 14, 16 or even 24 bits for each colour channel are increasingly being employed. Increasing the quantization degree of the LCD display requires that the drive circuits are modified to operate with finer resolution. However, this substantially increases the complexity and thus the cost thereof. For example, drive circuits often utilise look-up tables for calculating a drive amplitude for a panel as a function of the image data value. The size of this look-up table doubles for each additional bit of the input word and also increases for each additional bit of the output bit. Thus, each additional bit supported by the drive circuit more than doubles the required memory for the look-up table.

Typically the finely quantized image data is simple to convert to the coarser drive circuit quantization (e.g. simply by considering only the most significant bits and discarding the least significant bits). However, such a coarser quantization results in a degradation of the image quality of the presented image compared to that possible from the image data. In particular, the coarser quantization may introduce noticeable contouring artefacts.

Hence, an improved approach would be advantageous and in particular a system allowing increased flexibility, reduced complexity, reduced resource requirements, facilitated implementation, improved image quality, increased luminance quantization and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided display panel control apparatus for a display panel, the apparatus comprising: a receiver for receiving image data for an image to be displayed by the display panel in at least a first field and a second field; a first driver for generating a first drive signal for at least a first pixel of the display panel for the first field in response to an image pixel value for the first pixel, the first drive signal having a value selected from a first set of discrete quantized values and corresponding to a first radiated luminance level, each discrete quantized value of the first set corresponding to a discrete radiated luminance level from the display panel for the first field; a second driver for generating a second drive signal for the first pixel of the display panel for the second field in response to the image value for the first pixel, the second drive signal having a value selected from a second set of discrete quantized values and corresponding to a second radiated luminance level, each discrete quantized value of the second set corresponding to a discrete radiated luminance level from the display panel for the second field; wherein the first and second radiated luminance levels are different and have a combined radiated luminance corresponding to a luminance level of the first pixel in the image, and the first set and the second set of discrete quantized values combine to generate a combined set of discrete values of the combined radiated luminance having a larger number of discrete quantized values than either of the first set and the second set.

This may in many scenarios provide an improved performance and/or facilitated implementation. In particular, an improved image quality may often be achieved without requiring substantially more complex drive circuitry. A perceived higher quantization degree for the luminance of the pixel may often be achieved.

The approach may specifically utilise the perceptual averaging of luminance performed by a viewer when perceiving individual fields having different luminance levels. The first and second fields may specifically have a duration of 100 msec, 50 msec, 10 msec or less. For a 60 Hz display, two fields may result in a field frequency of 120 Hz and thus in a duration of each field of substantially 8 msec. For a 50 Hz display, two fields may result in a field frequency of 100 Hz and thus in a duration of each field of substantially 10 msec. The driving of the display panel to provide different luminance levels in the two fields may provide improved flexibility.

The invention may allow a perceived quantization of the luminance for the pixel which is higher than the quantization used in either of the first and second drivers. Thus, the number of discrete values in each of the first set and the second set is lower than the number of discrete values in the combined set. This may allow an improved image quality to be provided while allowing low complexity drivers to be used.

The discrete values of the first and second sets may be selected such that at least one of the combinations of radiated luminances average to provide a perceived radiated luminance which is different from the luminances that can be radiated in either the first field or the second field. Thus the radiated luminances during the first and second fields may be controlled such that they result in an average radiated luminance over the two fields, which is different than any actual radiated luminance that can be generated by the drivers.

The first and second fields may both present the same image such that the pixel values of both fields are dependent on the same image data. The approach may be applied to all or only some pixels of the display panel. The pixel may specifically be a coloured subpixel of a multi-colour pixel, such as e.g. a Red, Green or Blue subpixel of an RGB pixel of an RGB display.

The luminance level of the first pixel corresponds to the luminance indicated by the image value for the first pixel.

In the system, the first and second drivers are arranged to generate the first and second driver signals respectively such that the first and second radiated luminance levels are different and have a combined luminance corresponding to the luminance level of the first pixel in the image. The first and second drivers may specifically assume a predetermined relationship between the first and second driver signals and the first and second radiated luminance levels.

The discrete values of the first and second set may be selected such that at least one of the combinations of radiated luminances average to provide a perceived radiated luminance which is different from the luminances that can be radiated in either the first field or the second field. Thus the radiated luminances during the first and second fields may be controlled such that they result in an average radiated luminance over the two fields which is different than any actual radiated luminance that can be generated by the drivers.

In accordance with an optional feature of the invention, the first set and the second set of discrete quantized values combine to generate a combined set of discrete values of the combined radiated luminance having a larger number of discrete quantized values than the sum of discrete quantized values in the first set and the second set.

In accordance with an optional feature of the invention, the discrete radiated luminance levels for the first field are different from the discrete radiated luminance levels of the second field for at least one luminance interval.

This may allow improved image quality and may in particular allow a high number of different combined radiated luminance levels to be generated while maintaining low complexity of the individual drivers.

The luminance interval may specifically include a plurality of discrete luminance levels of the combined radiated luminance and/or discrete quantized values of the first set and/or the second set. The luminance interval may especially cover the available radiated luminance range except for one or both of the extreme intervals. Thus, in some embodiments, the luminance interval may cover the available radiated luminance range except for a lowest luminance interval and/or a highest luminance interval. Specifically, the luminance interval may cover the entire range of possible radiated luminances except for the darkest (lowest luminance) and/or brightest (highest luminance) N discrete values of the first and/or second set of discrete quantized values. N may advantageously in many embodiments be 1 or in some embodiments 2 or 3.

The luminance interval may depend on an image characteristic. For example, the interval may depend on how dark or bright the image (or part of the image) is.

In some embodiments, at least 80% of the discrete radiated luminance levels for the first field are different from the discrete radiated luminance levels of the second field.

In accordance with an optional feature of the invention, the combinations of the discrete radiated luminance levels for the first field and the discrete radiated luminance levels for the second field are different for at least one luminance interval.

This may allow improved image quality and may in particular allow a particularly fine perceived radiated luminance quantization while maintaining low complexity of the individual drivers.

The luminance interval may specifically include a plurality of discrete luminance levels of the combined radiated luminance and/or discrete quantized values of the first set and/or the second set. The luminance interval may especially cover the available radiated luminance range except for one or both of the extreme intervals. Thus, in some embodiments, the luminance interval may cover the available radiated luminance range except for a lowest luminance interval and/or a highest luminance interval. Specifically, the luminance interval may cover the entire range of possible radiated luminance except for the darkest (lowest luminance) and/or brightest (highest luminance) N discrete values of the first and/or second set of discrete quantized values. N may advantageously in many embodiments be 1 or in some embodiments 2 or 3.

The luminance interval may depend on an image characteristic. For example, the interval may depend on how dark or bright the image (or part of the image) is.

In some embodiments, at least 80% of the combinations of the discrete radiated luminance levels for the first field and the discrete radiated luminance levels for the second field are different.

In accordance with an optional feature of the invention, the discrete radiated luminance levels for the first field correspond to a non-linear quantization of a radiated luminance from the first pixel.

In some embodiments, the discrete radiated luminance levels for the second field may also correspond to a non-linear quantization of a radiated luminance from the first pixel.

This may allow improved image quality and may in particular allow a high number of different combined radiated luminance levels to be generated while maintaining low complexity of the individual drivers. The first and/or second driver may specifically provide a non-linear monotonic distribution of the discrete radiated luminance levels. In some embodiments, both the first and second drivers may use a non-linear distribution and the two distributions may specifically be different for the two drivers. The non-linear distribution may specifically be a logarithmic distribution.

In accordance with an optional feature of the invention, the display panel control apparatus further comprises means for determining discrete quantized values of at least one of the first set and the second set in response to an image characteristic.

This may provide an improved image quality in many embodiments. Specifically, it may allow the quantization of the drivers, and thus of the combined radiated luminance, to be adapted to the specific characteristics of the specific image. This may for example reduce quantization errors for the specific image relative to the use of a predetermined quantization. The image characteristic may be a global image characteristic or may be a local image characteristics, such as an image characteristic determined only for a part (an area) of the image.

In accordance with an optional feature of the invention, the image characteristic comprises a luminance distribution characteristic for an area of the image.

This may provide improved image quality. For example, it may allow the quantization steps of the combined radiated luminances to be adapted such that the perceived quantization error is minimized. For example, for dark images, the quantization steps may be adapted to be relatively finer for darker values (lower luminosity) than for lighter values (higher luminosity). In contrast, for relatively light images, the quantization steps may be adapted to be relatively finer for lighter values (higher luminosity) than for dark values (lower luminosity).

In accordance with an optional feature of the invention, the display panel control apparatus further comprises means for determining discrete quantized values of at least one of the first set and the second set in response to a display characteristic for the display panel.

This may provide an improved image quality in many embodiments. Specifically, it may allow the quantization of the drivers, and thus of the combined radiated luminance, to be adapted to the specific characteristics of the display panel thereby allowing it to compensate for the specific characteristics. This may for example reduce quantization errors for the display panel relative to the use of a predetermined quantization.

In accordance with an optional feature of the invention, the display characteristic comprises a response time characteristic.

This may allow a more accurate setting of the radiated luminance taking into account not only the static characteristics but also a temporal characteristic affecting the perceived combined radiated luminance level.

In accordance with an optional feature of the invention, the display panel control apparatus further comprises means for determining discrete quantized values of at least one of the first set and the second set in response to a minimisation of a cost function indicative of a difference between the discrete values of the combined set and a desired radiated luminance distribution.

This may provide improved image quality while maintaining low complexity. The desired radiated luminance distribution may be provided as a function of image data values. The desired radiated luminance distribution may be a quantized function, which specifically may have substantially the same number of quantized levels as discrete values in the second set.

In accordance with an optional feature of the invention, the first drive signal comprises a first pixel drive signal specific to the first pixel and the second drive signal comprises a second pixel drive signal specific to the first pixel, the first driver is arranged to generate the first pixel drive signal as a first function of the image pixel value, and the second driver is arranged to generate the second pixel drive signal as a second function of the image pixel value wherein the first function and the second function are different.

This may provide improved flexibility and freedom in separately driving the two fields.

Specifically, the first and second functions may be functions that are differently quantized and which provides different discrete values of the radiated luminances. For example, the first function may (at least partly) be defined by a first look-up table and the second function may (at least partly) be defined by a second look-up table. The first and second look-up tables may be separate thereby allowing the independent selection of the two sets of discrete values for the first and second fields.

In some embodiments, the quantizations of the first and second functions may be different. Indeed, the first and second function may have substantially the same underlying non-quantized non-linear function but may provide different quantizations thereof. In particular, the first and second functions may represent substantially the same relationship between the image pixel value and the radiated luminance but with different selections of the discrete values.

The first drive signal and the second drive signal may be determined as different functions of the image data.

In accordance with an optional feature of the invention, the second function is generated by introducing at least one of an offset and a multiplication to the first function.

This may reduce complexity in many embodiments. For example, it may allow a complex first function to be used with a low complexity modification of this to achieve the second function. This may allow substantially facilitated implementation. For example, an underlying quantized non-linear function may be represented by a look-up table which can be used for both the first and second fields with the luminance difference between the fields being introduced by a simple addition, subtraction or multiplication. Such an operation may be applied directly to a drive signal for the pixel, and may e.g. be applied by analog circuitry.

The second driver may be arranged to generate the second drive signal from the first drive signal. Specifically, the second driver may be arranged to generate the second drive signal by applying at least one of an offset and an amplification (e.g. scaling, or multiplication) to the first drive signal. The second driver may be arranged to generate the second pixel drive signal from the first pixel drive signal. Specifically, the second driver may be arranged to generate the second pixel drive signal by applying at least one of an offset and an amplification (e.g. scaling, or multiplication) to the first pixel drive signal.

In accordance with an optional feature of the invention, the first drive signal comprises a first pixel drive signal specific to the first pixel and a first common drive signal common to a plurality of pixels, and the second drive signal comprises a second pixel drive signal specific to the first pixel and a second common drive signal common to the plurality of pixels wherein the first common drive signal is different than the second common drive signal.

This may reduce complexity in many embodiments. For example, it may allow the same approach and/or circuitry to generate the first and second pixel drive signals while introducing the luminance difference between the fields by varying the level for the first common signal and the second common signal. This variation may typically be relatively simple whereas the generation of the pixel drive signals may typically be more complex and thus the approach may allow reduced overall complexity.

The first and second common drive signals may specifically be backlight drive signals which drive a backlight of the display panel. Thus, a backlight jitter may be introduced between the two fields. The backlight may be common to only an area of the display or may be a common backlight for the whole display panel.

The first pixel drive signal may be substantially the same as the second pixel drive signal.

According to an aspect of the invention there is provided a display system comprising a display panel control apparatus as referenced above as well as the associated display panel.

The invention may provide an improved display system.

According to an aspect of the invention there is provided a method of controlling a display panel, the method comprising: receiving image data for an image to be displayed by the display panel in at least a first field and a second field; generating a first drive signal for at least a first pixel of the display panel for the first field in response to an image pixel value for the first pixel, the first drive signal having a value selected from a first set of discrete quantized values and corresponding to a first radiated luminance level, each discrete quantized value of the first set corresponding to a discrete radiated luminance level from the display panel for the first field; generating a second drive signal for the first pixel of the display panel for the second field in response to the image value for the first pixel, the second drive signal having a value selected from a second set of discrete quantized values and corresponding to a second radiated luminance level, each discrete quantized value of the second set corresponding to a discrete radiated luminance level from the display panel for the second field; wherein the first and second radiated luminance levels are different and have a combined radiated luminance corresponding to a luminance level of the first pixel in the image and the first set and the second set of discrete quantized values combine to generate a combined set of discrete values of the combined radiated luminance having a larger number of discrete quantized values than either of the first set and the second set.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of a display system in accordance with some embodiments of the invention;

FIG. 2 is an illustration of an example of a display system in accordance with some embodiments of the invention;

FIG. 3 is an illustration of an example of a display system in accordance with some embodiments of the invention;

FIG. 4 is an illustration of an example of a display system in accordance with some embodiments of the invention; and

FIG. 5 is an illustration of an example of a display system in accordance with some embodiments of the invention;

### DETAILED DESCRIPTION OF SOME EMBODIMENTS OF THE INVENTION

The following description focuses on embodiments of the invention applicable to an LCD display where each image is represented by two consecutive fields. However, it will be appreciated that the invention is not limited to this application but may be applied to many other displays including for example OLED and plasma displays and/or systems wherein each image is represented by more than two fields.

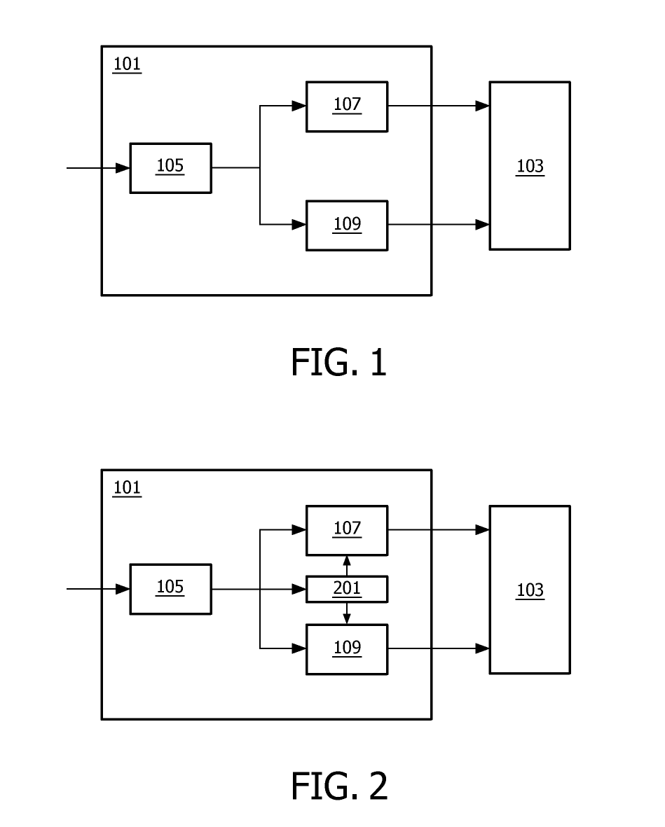

FIG. 1 illustrates an example of a display system in accordance with some embodiments of the invention. The system comprises a display controller 101 which is coupled to a display panel 103 which in the specific example is an LCD display panel. The display controller 101 receives images and generates corresponding drive signals that are fed to the display panel 103 to cause this to present the images.

Specifically, the display controller 201 comprises a receiver 105 which receives an image to be displayed by the display panel 103. The image may specifically be received as part of a video signal comprising a sequence of images. In the following, the image will specifically be considered to be a (decoded) frame of a video signal.

In the system, each input image or input frame (in case of a video sequence) is presented in a plurality of fields (also called subframes), which are presented sequentially by the display. Typically, if the refresh rate is fast enough and the observer does not move his/her eyes, the eyes integrate the fields and the observer sees the original input image.

The following description will focus on examples where each image/frame is presented in two consecutive fields. As a specific example, many current displays have a refresh rate of 120 Hz or more. However, video sequences tend to have a 60 Hz frame rate and accordingly the video signal is upconverted to the refresh rate of the panel. This is performed by using a plurality of fields for each frame. E.g. for a 120 Hz display, two fields are used to render each 60 Hz input image.

It will be appreciated that in other embodiments more than two fields may be used. For example, for a 180 Hz display, each 60 Hz input image may be presented using three consecutive fields.

In the example of FIG. 1, the display controller 201 generates a first drive signal for the first field and a second drive signal for the second field. It will be appreciated that although the drive signals for the first and second drive signals are described as separate signals, this does not imply that they may not be combined into a single signal comprising both drive signal components. For example, the first and second drive signals may be time multiplexed into a single electrical signal or a single data/bit stream provided to the display panel 103. It will also be appreciated that the drive signals may be analog signals and/or digital signals. Furthermore, the drive signals may be electrical signals or may be data/bit streams.

The display controller 201 of FIG. 1 comprises a first driver 107 and a second driver 109 which are coupled to the receiver 105 and the display panel 103. The two drivers 107, 109 receive the image data that characterises the image to be presented. In the specific example the image may be a black and white image represented by a grey level for each pixel of the display panel. As another example, the image may be a colour image represented by a plurality of colour channels with a luminance value for each colour channel provided for each pixel. For example, the image data may be provided as RGB (Red Green Blue) luminance values.

The first driver 107 receives the image data and proceeds to generate a first drive signal for the first field. The first drive signal is generated from the image data to provide a desired radiated luminance from the display panel 103 during the first field (also referred to as the front-of-screen luminance). Similarly, the second driver 109 receives the image data and proceeds to generate a second drive signal for the second field. The second drive signal is generated from the image data to provide a desired radiated luminance from the display panel 103 during the second field.

In the following, the operation of the display controller 201 will be described predominantly with reference to a single pixel. Thus, the description will focus on how one pixel of the display panel is controlled to provide the desired luminance, i.e. the luminance corresponding to the image data for that pixel. However, it will be appreciated that the same approach may be used for other pixels of the display panel/image and that in particular the described approach may be applied for all pixels of each image/frame of the video sequence.

Furthermore, the following description will for brevity and clarity focus on an embodiment wherein the image is a black and white (grey level) image and the display is a black and white (grey level) display. Thus, in the example, the image data comprises one luminance value for each pixel and each pixel of the display panel is arranged to radiate a non-coloured light (i.e. each pixel radiates a single grey level).

However, it will be appreciated that the described approach is equally applicable to colour displays. In particular, the description of the luminance control for the black and white embodiment may directly be applied to the luminance control for each individual colour channel. Specifically, the described approach may directly be applied to the individual R, G and B colour channel of an RGB display using the R, G and B data values from the colour image data. Thus, the luminance (including references to grey levels) of the following description may be considered to correspond to a luminance of a grey level channel or to an individual colour channel. Similarly, the pixel may be considered to correspond to a non-colour specific grey level pixel or may be considered to correspond to a colour sub-pixel (e.g. the R, G or B subpixel) of a combined colour pixel.

Thus, in the system of FIG. 1 the first driver 107 generates a first drive signal for a pixel of the display for the first field in response to the image pixel value for the pixel. Similarly, the second driver 109 generates a second drive signal for the pixel for the second field in response to the same image pixel value.

The drive signals are generated such that the radiated luminance from the display panel in the respective field has the desired value for the image data value. However, it will be appreciated that the specific function between the drive signal value and the radiated luminance depends on the specific characteristics of the individual embodiments. Specifically, the required drive signal to provide a desired radiated luminance will depend on the specific characteristics of the display.

Furthermore, the desired radiated luminance for a given image data value also depends on the specific embodiment and the desired image characteristics. Indeed, display systems tend to provide a non-linear relationship between the linear image data (e.g. RGB) and the radiated luminances. Specifically a power law (a gamma compensation) is typically applied with a power (gamma) being varied to provide the desired image characteristics.

More specifically, the desired radiated luminance for a pixel as a function of the image data value for the pixel may be represented as:

l=f(x),

where l represents the radiated luminance and x represents the input image data value. A typical power or gamma law may for example use:

f(x)=c·x^{γ}

where c is a suitable design constant and γ may be selected to provide the desired characteristics. Often γ may be set to 2.2.

Similarly, the relationship between the drive signal value and the radiated luminance may be given as:

l=g(y),

where y is the drive signal value.

It follows that if the desired radiated luminance is known, the required drive signal value can be calculated as:

y=g⁻¹(l)

It also follows that the required drive signal value for a given input image data value can be determined as:

y=g⁻¹(f(x))

Thus, by applying these calculations, the drive signal level for each field can be determined directly from the input signal value.

In conventional displays, the frame rate upscaling is simply performed by repeating the image in the two displays. However, in the system of FIG. 1, different radiated luminance levels are generated in the two fields for the same image data for at least some values. Thus, the radiated luminance for the same pixel is different in the first and second fields. However, due to the high refresh rate and the relative slowness of the human visual perceptionn, a viewer does not detect these differences but rather perceives the pixel to have a single luminance which is a combination of the luminance in the two fields. Specifically, the viewer will tend to accumulate/integrate the two luminances and thus only perceive the combined sum luminance:

lₛ=l₁+l₂

where l₁ and l₂ are the radiated luminances in the first and second fields respectively.

Thus, in the system of FIG. 1, the functions between the input value x and the desired luminance 1 are different for the first and the second fields. Thus, the first driver 107 is based on the function:

l₁=f₁(x)

and the second driver 109 is based on the function:

l₂=f₂(x)

where

f₁(x)≠f₂(x)

This results in the combined (perceived) luminance of:

lₚ=f₁(x)+f₂(x)

As the relationship between the drive signal values and the radiated luminances is the same for the two fields, this further results in the two different functions between the image data value and the drive signal values.

Thus, the first driver 107 generates the first drive signal according to the function:

y₁=g⁻¹(f₁(x))

and the second driver 109 generates the second drive signal according to the function:

y₂=g⁻¹(f₂(x)).

The functions are typically generated as a monotonically increasing non-linear function of the image pixel value.

The system of FIG. 1 accordingly uses different functions and relationships between the input data value and the drive signal for the two fields. This provides an increased degree of freedom and allows improved control of the luminance. For example, in some embodiments the approach may be used to allow the luminance control to maintain a high luminance in at least one field for mid-level luminosities. For example, a mid-grey value of half the maximum radiated luminance may be achieved by a radiated luminance close to the maximum value in the first field and a radiated luminance close to the minimum value in the second field. This may e.g. improve the image quality for off-axis viewing as this the degradation with increasing viewing angle is less for increasing luminances being radiated.

Furthermore, the approach may allow an effective quantization increase for the luminance. For example, a conventional LCD panel may be controlled with a resolution of n bits resulting in N=2ⁿ quantization levels for the quantization. Thus, a conventional display can only display N different luminance levels (even if two identical fields are used) and this may result in degraded image quality.

The described approach allows the luminance to be generated differently in the two fields thereby allowing the combined luminosity to be controlled by two radiated luminance values which each have a resolution of n bits. Accordingly, a combined luminance with up to N=2²ⁿ different quantization steps can achieved. Thus, a squaring (N·N) of the quantization levels for the luminance may be achieved. This may result in a substantially improved image quality and in particular may result in reduced contouring effects. For example, for an n=8 bit display, the number of luminance levels could be increased from 256 discrete levels to 65,336 discrete levels.

In the system of FIG. 1, the first driver 107 generates a drive signal with values that are selected from a first set of discrete quantized values. Each of the discrete quantized values correspond to one level of the drive signal and thus to one discrete value of the radiated luminance level. Thus, each discrete quantized value of the first set corresponds to a discrete radiated luminance level from the display panel for the first field in accordance with the equation:

l₁=g(y₁)

where the index refers to the first field and y₁ is quantized into a set of discrete values and consequently l₁ is also quantized into a set of discrete values.

Similarly, the second driver 107 generates a drive signal with values that are selected from a second set of discrete quantized values. Each of the discrete quantized values correspond to one level of the drive signal and thus to one discrete value of the radiated luminance level. Thus, each discrete quantized value of the second set corresponds to a discrete radiated luminance level from the display panel for the second field in accordance with the equation:

l₂=g(y₂)

where the index refers to the second field and y₂ is quantized into a set of discrete values and consequently l₂ is also quantized into a set of discrete values.

Although the first and second sets comprise quantized drive signal values, these correspond directly to quantized radiated luminance values as represented by the function

l=g(y).

However, as the function is dependent on the specific embodiment, the quantisation provided by the first and second sets will be described with reference to the radiated luminance values, and the first and second set will comprise the drive values that correspond to these discrete radiated luminance values (as dependent on the specific function for the specific embodiment). Although the first and second set comprises drive values, the sets will for brevity also be referred to as comprising discrete radiated luminance values as simplified reference to the drive values that directly correspond to these radiated luminance values.

The combined radiated luminance given by

lₚ=g(y₁)+g(y₂)

is accordingly also quantized. However, the set of discrete values that the combined radiated luminance lₚ can attain is in the system of FIG. 1 larger than the number of discrete values in each of the first set of discrete drive level values and in the second set of discrete drive level values. Thus, the combined radiated luminance can be selected from a combined set of discrete values which is higher than the number of discrete values that can be presented in either the first or the second fields.

As a first example, the N quantized luminance levels may be selected identically for the two fields and may furthermore be selected linearly. Thus, in this example, the first and second sets of discrete values may be selected to be identical and linear.

As an explanatory example, the following table illustrates the possible selection of discrete values for an example where the grey level is represented by three bits in each field, i.e. where the first and second sets include eight discrete values. In the example, F1 refers to the first set (with each value represented by a row of the table) and F2 refers to the second set (with each value represented by a column of the table). The values of the table are normalised relative to the maximum luminance. Thus, the maximum combined luminance for the two fields together is normalized to 1 resulting in the maximum luminance of each field being 0.5. Furthermore, the presented values relate to the radiated luminances (i.e. to the front-of-screen luminance). The corresponding drive values of the first and second set are thus given by y=g⁻¹(l). In the table, the table value for row x, column y is the normalized combined radiated luminance when the radiated luminance of the first field is that of row x and the radiated luminance of the second field is that of column y.

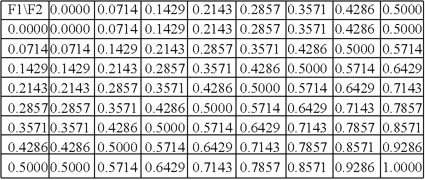

As can be seen the approach results in an increased number of different possible values of the combined radiated power (indicated by a grey shading). However, as can also be seen, the approach results in a number of combinations of the pairs of radiated luminances resulting in the same combined radiated luminance. Indeed, in the specific example, the number of quantized values of the combined radiated luminance is increased from 8 to 15, i.e. approximately one bit extra of grey level (colour channel luminance) resolution is achieved.

In other embodiments and examples, the discrete values are selected such that the radiated luminances of the first field and the second field tend to not add up to the same combined luminances. In particular, the values may be selected such that the combinations of the discrete radiated luminance levels for the first field and the discrete radiated luminance levels for the second field are different for at least a luminance interval. E.g. in some embodiments at least 80% of the combinations of the discrete radiated luminance levels for the first field and the discrete radiated luminance levels for the second field are different. In some embodiments, the discrete values in the first and second set are selected such that the resulting radiated luminances do not combine to the same value for any two pairs of the possible values selected from the first and second set.

Specifically, the discrete values of the first and second set may be selected such that the corresponding luminance levels for the first and second fields are different within the luminance interval. E.g. in some embodiments at least 80% of the values may be different and thus the discrete values of the first and second sets may be selected such that at least 80% of the discrete radiated luminance levels for the first field are different from the discrete radiated luminance levels of the second field.

The quantized values in the sets and/or the combinations may thus advantageously be selected to be different in a luminance interval. The luminance interval may be represented as an interval of the radiated luminance, of the drive signal values and/or of the input pixel image value. The luminance interval may often be determined as most (or in some cases the whole) of the available luminance range. In particular, it may correspond to the entire dynamic luminance range for the display but e.g. except for an interval at the highest and/or lowest luminance ends of the range. Thus, in some embodiments the same quantized values of the discrete sets may be used for the brightest luminance and for the darkest luminance. This may provide an improved representation of dark or bright pixels as the combined radiated luminance may still be the brightest or darkest possible. However, except for these extreme values, different quantised values may be used in order to provide an increased number of different combined luminance values. In some embodiments, the darkest and/or brightest two or three quantised values may be selected to be the same.

In some embodiments, the luminance interval (and thus the values that are allowed to be identical) may be dependent on an image characteristic and especially on a luminance characteristic. For example, for a very dark image, the lowest luminance quantised values may be the same in order to allow an improved representation of black whereas the highest luminance levels are selected to be different in order to provide improved granularity at mid range and brighter luminances (and since the image may not need to represent the brightest possible values). For a very bright image, the exact opposite may be the case, i.e. the highest luminance values are allowed to be the same but the darkest luminance values are kept different. This may allow improved representation of the brightest areas while maintaining improved quantisation in darker areas.

In most embodiments, the relationship between the drive signal levels and the radiated luminance is the same for both fields and is furthermore a continuous monotonic function (i.e. l=g(y) is a monotonic function and is the same for the first and second fields) It follows that different radiated luminance levels accordingly require different drive signal values. Thus, in many embodiments the discrete values of the first and second set are selected to be different for at least 80% of the number of values in the sets.

In some embodiments, the discrete values of the first and second sets are selected such that all possible radiated luminance values in the first field are different from all possible radiated luminance values in the second field. This may in many embodiments provide an increased number of possible discrete combined radiance values. However, in other embodiments, the discrete values of the first and second sets are selected such that all possible radiated luminance values in the first field are different from all possible radiated luminance values in the second field except for one or two radiated luminance values. Thus, the first and second set may contain one or two shared values that results in the same radiated luminance. Such a shared luminance may specifically be a zero radiated luminance, i.e. the minimum possible radiated luminance. This may allow an improved representation of black by the display. Alternatively or additionally, the shared luminance may be a maximum radiated luminance, i.e. the maximum possible radiated luminance. This may allow an improved representation of bright areas by the display.

The improved variation in the possible combinations may for example be achieved by selecting the discrete radiated luminance levels for the first field to correspond to a non-linear quantization of the radiated luminance curve for the first pixel. Similarly, the discrete radiated luminance levels for the second field may be selected to correspond to a non-linear quantization of the radiated luminance curve for the first pixel. Specifically, the quantization of the radiated luminances may be selected as a logarithmic or power based quantization. For example, most of the discrete radiated luminance values may be selected as a certain percentage higher than the previous value (e.g. 0.02% higher). This tends to result in a perceptually equivalent (non-linear) step between each discrete value.

Thus, in many embodiments, the number of luminance levels that can be represented is increased by selecting the possible discrete luminance levels in the two fields differently.

In such embodiments the set of radiated luminance levels in the first set F1 are different from the set of radiated luminance levels in the second set F2 for most of the luminance levels (typically the minimum and maximum luminance level is the same for both fields, all others are different). Furthermore, the values are selected such that all possible combinations of a value from the first set F1 and a value from the second set F2 result in different combined luminance levels. Typically this is the case when both sets have different radiated luminance levels that are monotonically increasing in a non-linear manner. For example with a power law (D=[0:255]; F1=(D/255)^{2.2}; F2=((D+0.5)/255)^{2.2}.

In the following the approach will be clarified with reference to the previous specific example of n=3 and N=8.

In the first specific example, the radiated luminance levels are selected equally for the two fields but correspond to a logarithmic quantization. In this case, a lot more additional gray levels can be created by the sum of the two fields. Typically the number of different combined radiated luminance levels that can be generated are N*(N−1)/2+N. For example, if both fields use discrete values given by l=((a/7)^{γ})/2, where a=[0, 1, 2, 3, 4, 5, 6, 7] and γ=2.2, the sum of the two fields can make the values shown in the following table.

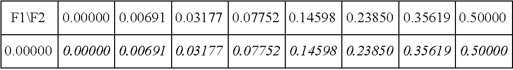

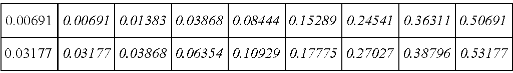

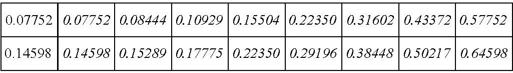

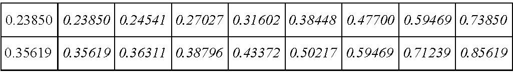

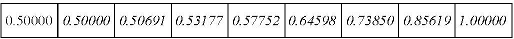

It can be seen that the combined radiated luminance is quantized into 8·(8−1)/2+8=36 different luminance levels, which is more than four times the number of luminance levels of a conventional (three bit) display with two identical fields.

If the radiated luminance levels are selected to be different for the two fields and are further chosen linearly, it is possible for all combinations of the two radiated luminance levels to be different. Thus, a total of N² different luminance levels can be represented. For example, the radiated luminance levels may be selected as:

$${l}_{1} = \frac{a}{7} \cdot \frac{1}{2} ( 1 + \frac{δ}{2} )$$

and

$${l}_{2} = \frac{a}{7} \cdot \frac{1}{2} ( 1 - \frac{δ}{2} )$$

with e.g. δ=⅛.

This results in the following discrete values:

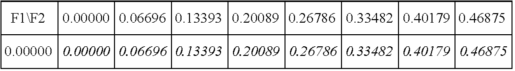

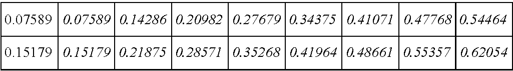

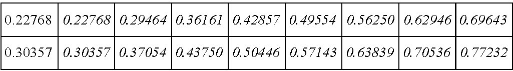

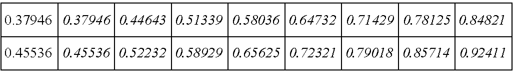

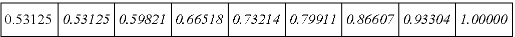

Thus resulting in 64 different values compared to the 8 different values achievable with a conventional display.

As another example, the radiated luminance levels can be selected to be different for the two fields and are further chosen non-linearly, and specifically logarithmically. It is also possible in this scenario for all combinations of the two radiated luminance levels to be different. Thus, a total of N² different luminance levels can be represented. For example, the radiated luminance levels may be selected as:

$${l}_{1} = {( \frac{a}{7} \cdot \frac{1}{2} )}^{γ} ( 1 + \frac{δ}{2} )$$

and

$${l}_{2} = {( \frac{a}{7} \cdot \frac{1}{2} )}^{γ} ( 1 - \frac{δ}{2} )$$

with e.g. δ=⅛ and γ=2.2.

This results in the following discrete values:

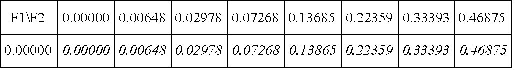

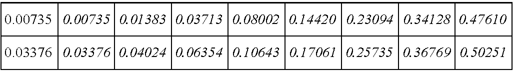

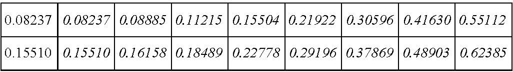

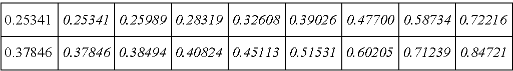

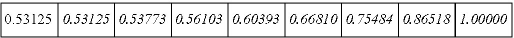

Thus resulting in 64 different values compared to the 8 different values achievable with a conventional display.

As yet another example, the discrete values of the radiated luminance values may be selected as the odd and even pairs of a set of logarithmically distributed luminance values. For example, a set of discrete values may be generated as

$$l = {( \frac{b}{15} )}^{γ}$$

with b=[0, 1, 2, . . . , 13, 14, 15] and e.g. δ=⅛ and γ=2.2. The values of the first set may then be selected as every other value starting with b=0 (i.e. the values for b even) and the second set may be selected as every other value starting with b=1 (i.e. the values for b odd). The radiated values may be normalised relative to the maximum combined radiated luminance.

This results in the following discrete values:

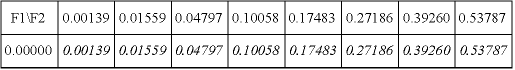

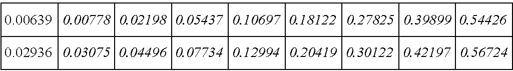

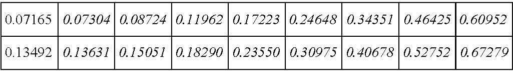

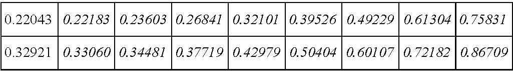

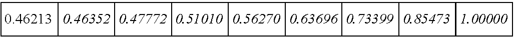

Thus resulting in 64 different values compared to the 8 different values achievable with a conventional display.

Although the quantization of the combined radiated luminance in the above examples is increased to 2²ⁿ the resulting discrete values are not necessarily distributed optimally for the specific embodiment.

Indeed, in some embodiments the discrete quantized values of at least one of the first set and the second set may be determined in response to a minimisation of a cost function indicative of a difference between the discrete values of the combined set and a desired radiated luminance distribution.

For example, the desired luminance distribution may be that represented by the non-quantized function:

lₚ(x)=f₁(x)+f₂(x)

The combined radiated luminance taking into account the quantization may be represented as

[symbol]

lₚ(x) [symbol] = [symbol] f₁(x) [symbol] + [symbol] f₂(x)

[symbol]

where [symbol] [symbol] denotes quantization into a number of discrete levels.

An error value for a given image data value is thus given as:

[symbol]

lₚ(x) [symbol] −lₚ(x)

A suitable error function for the applied quantization may be defined as:

e=∫ₓ| [symbol] lₚ(x) [symbol] −lₚ(x)|dx

In some embodiments, the discrete values of the combined radiated luminance may then be determined by a minimisation of the error function e.

It will be appreciated that the described approach may be modified in different ways. For example, the minimisation of the error value e may be only one parameter out of several taken into account. Also, in some embodiments, the error value may be weighted in the integration. For example, the wweighting may be determined on the basis of psychovisual characteristics (e.g. in the dark areas a deviation may be more noticeable than in light areas and thus errors in dark areas may be weighted higher than in light areas), physical display characteristics, context (e.g. if there is a lot of surround light reflecting on the display it may be desirable to have better accuracy for the mid-luminance values), picture properties, etc.

The desirable luminance function may for example be determined as a linear luminance curve. However, in other embodiments, the luminance may e.g. be a logarithmic luminance curve. In some embodiments, the desired luminance may be defined in the quantized domain. For example, it may be desired that the discrete levels are a series of variable steps with e.g. each step providing, say 0.02%, more light than the previous one, corresponding to a just noticeable difference for the human perception. Thus, the desired luminance function itself may be determined by quantizing the non-quantized luminance curve in accordance with a desired quantization.

Furthermore, in some embodiments, the error function does not span all driving values but only a subset of these, such as only darker or only lighter values. This may for example be image dependent.

In some embodiments, the display controller 101 may be arranged to dynamically select discrete quantized values for at least one of the first set and the second set in response to an image characteristic. Thus the quantization of the luminance from the display may automatically be adapted to match the specific characteristics of the image. An example of such a system is illustrated in FIG. 2 which corresponds to the system of FIG. 1 except that the display controller 101 further comprises a quantization processor 201 which receives the image data from the receiver 105 and which in response proceeds to determine the discrete drive values used by the first driver 107 and the second driver 109.

The image characteristic my specifically comprise a luminance distribution characteristic for an area of the image. The area may be the whole image as such or may correspond to a subsection thereof.

For example, the quantization processor 201 may proceed to generate a histogram of the luminance levels of the input image. Depending on this histogram, different quantizations may be selected. For example, for a dark image more emphasis may be assigned to the reproduction of dark levels rather than light levels. Thus, a finer quantization is provided for dark rather than light luminances. This may be accomplished be providing a relatively higher number of discrete values for the lower values of the combined radiated luminance than for the higher values. Thus, both the first and second set may have a larger concentration of discrete values for the darker radiated luminances than for the lighter radiated luminances.

This adaptation may be performed locally rather than globally for the entire image. Indeed, depending on the input image it can be desirable to have different sets of discrete values for different areas of the image. For example in a darker corner of an image, the first and set may be selected to have more dark grey levels compared to the first and second set used in a light corner of the image. This can be accomplished by changing the set of discrete values for the first and second fields locally.

In some embodiments the discrete quantized values of at least one of the first set and the second set may be dependent on a display characteristic for the display panel. Thus, in some embodiments the quantization processor 201 of FIG. 2 may be arranged to vary the discrete values used for the quantization dependent on a display characteristics.

The display characteristic may specifically be a response time characteristic and thus the actual values used for the drive signals to generate the combined radiated luminance may be dependent on a response characteristic. For example, a bias may be applied to one or more of the quantized levels to compensate for a response time variation.

It will be appreciated that in some embodiments, the first and/or second drive signal may be dependent on a response time characteristic for the display panel.

Indeed, the radiated combined luminance level may be dependent on the response time of the pixel (e.g. LC response time in case of an LCD display) and the difference between the two luminance levels of the two fields. Typically it takes some time to switch from one luminance level to another one. As the luminance levels of the two fields tend to be averaged/integrated by the human visual perception, a symmetric response time is unlikely to cause much deviation. However, if the response time is non-symmetric this may affect the perceived combined radiated luminance and may accordingly be compensated for by the display controller 101.

A practical approach for introducing such a compensation is to first measure the effective combined radiated luminance for all possible combinations of the radiated luminances in the first and second fields. The deviation from the desired response may then be determined and the quantized discrete values may be adjusted to compensate for this deviation.

In the example of FIG. 1, the different functions

y₁=g⁻¹(f₁(x))

y₂=g⁻¹(f₂(x)).

may be generated by the first and second drivers 107, 109 independently, e.g. using completely different look-up tables. Thus, the individual functions used by the first and second drivers 107, 109 may be implemented completely separately thereby allowing a large degree of freedom in choosing suitable drive values. The look up tables my directly provide a drive value for each possible input data value. Thus, in this example, the different luminance levels in each field may be achieved simply by changing the “gamma” lookup table used for setting the drive level from the input data.

However, whereas such an approach may provide a high degree of freedom, it is not optimal for all situations. Indeed, the approach may in some cases not allow a desired backwards compatibility as most current display systems use a fixed lookup table for the conversion from the input data to the drive level signal. Therefore, in some embodiments the two different functions may be achieved using only a single look-up table. Specifically this may be achieved by using the look-up table to generate the first drive signal and then to generate the second drive signal by introducing a small relative variation to this value.

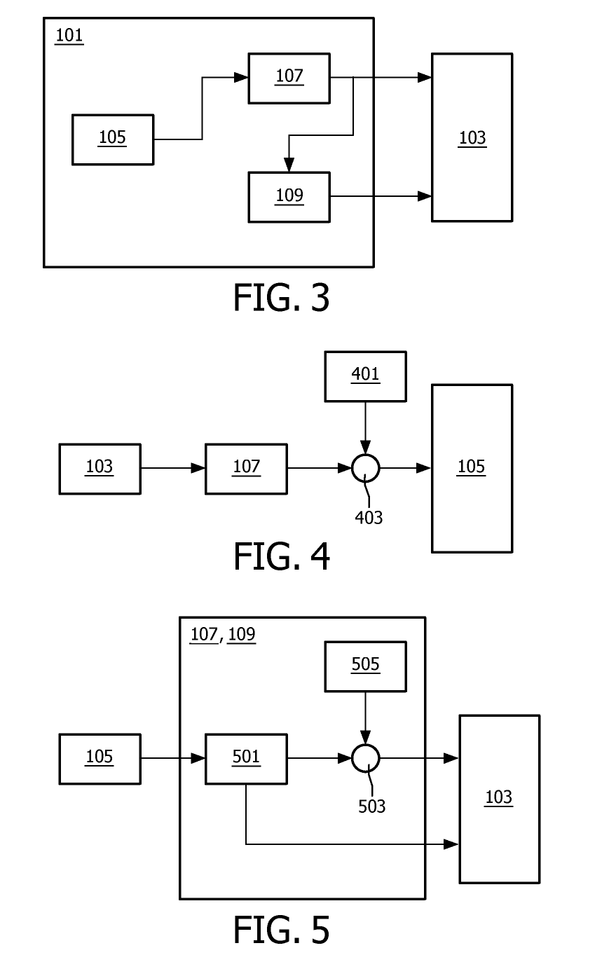

FIG. 3 illustrates an example where the second driver 109 merely reuses the first drive signal but introduces a variation to this signal. Specifically, the second drive 109 may simply introduce an offset or scaling of the first drive signal.

Thus, as illustrated in the example of FIG. 4, the second function may simply be generated by introducing at least one of an offset and a multiplication to the first function, i.e.

y₂=c₁·g⁻¹(f₁(x))+c₂

where at least one of c₁ and c₂ are non-zero. Thus, a variation between the two fields may be introduced simply by adding a constant value to the driving voltage of the panel drivers and/or by multiplication of the driving voltage with a constant factor which is different for the two fields.

FIG. 4 illustrates such an example where the second driver 109 is implemented by an offset processor 401 and a summer 403 which is coupled between the first driver 107 and the display panel 105. In this example, the offset processor 401 generates an offset which is zero for the first field and has a non-zero value for the second field. Thus a luminance offset is implemented between the fields using a very simple circuit which can easily be added to existing display panels. In the example, the first and second drive signals are thus effectively generated as a combined signal comprising both drive components in a time multiplexed manner.

In some embodiments, the luminance variation is achieved at least partly by varying a luminance of the display which is common for a plurality of pixels. For example, the luminance may be controlled by dynamically controlling a backlight common to a plurality of pixels and the transmission of each individual pixel.

Thus, the first drive signal may comprise both a common drive signal common to a plurality of pixels (a backlight drive signal) and a drive signal which is pixel specific. Similarly, the second drive signal may comprise both a common drive signal common to a plurality of pixels (a backlight drive signal) and a drive signal which is pixel specific.

In such an embodiment, the introduced luminance variation between the first and second fields may be achieved by varying the common drive signal. This may result in a different set of discrete values of the radiated luminance to choose from in the first and the second fields thereby allowing a potentially substantially increased number of possible values for the combined radiated luminance.

FIG. 5 illustrates an example wherein the common signal in the form of a backlight signal is varied between fields thereby providing non-identical first and second sets of discrete values.

Specifically, a luminance controller 501 generates a pixel specific signal for the first and second fields. Thus, in the example, the generated pixel specific signal corresponds to both the first and the second pixel specific signal combined/time multiplexed into a single signal. The pixel specific signal is generated using the same look-up table and thus has the same quantisation for both fields. Hence, for the same backlight, the first and second set of quantised values would be identical.

However, the luminance controller 501 furthermore generates a backlight signal which is fed to a summer 503 that is further coupled to a backlight jitter controller 505 which generates an offset signal which is zero for the first field and non-zero for the second field. The summer 503 generates a backlight signal which is fed to the display panel 103. Thus backlight signal varies between the fields such that a backlight variation is introduced between the first and the second fields. Accordingly, the same quantisation levels for the pixel specific signal results in two different sets of discrete radiated luminance values. In the example, the generated pixel specific signal corresponds to both the first and the second common signals combined/time multiplexed into a single signal.

The approach may thus achieve different luminance levels between the fields simply by giving the backlight a small offset between the two fields. For example, the backlight in the second field may be set 0.5 cd/m2 higher than for the first field resulting in the radiated luminance in the second field being 0.5 cd/m2 higher than for the first field.

Such an approach may be particularly advantageous in many embodiments because it may provide a high degree of background compatibility. In particular, different quantizations may be achieved simply by jittering the backlight intensity.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A display panel control apparatus for a display panel (103), the apparatus comprising:
a receiver (105) for receiving image data for an image to be displayed by the display panel (103) in at least a first field and a second field;
a first driver (107) for generating a first drive signal for at least a first pixel of the display panel (103) for the first field in response to an image pixel value for the first pixel, the first drive signal having a value selected from a first set of discrete quantized values and corresponding to a first radiated luminance level, each discrete quantized value of the first set corresponding to a discrete radiated luminance level from the display panel (103) for the first field;
a second driver (109) for generating a second drive signal for the first pixel of the display panel (103) for the second field in response to the image value for the first pixel, the second drive signal having a value selected from a second set of discrete quantized values and corresponding to a second radiated luminance level, each discrete quantized value of the second set corresponding to a discrete radiated luminance level from the display panel (103) for the second field;
wherein the first and second radiated luminance levels are different and have a combined radiated luminance corresponding to a luminance level of the first pixel in the image, and the first set and the second set of discrete quantized values combine to generate a combined set of discrete values of the combined radiated luminance having a larger number of discrete quantized values than either of the first set and the second set.

2. The display panel control apparatus of claim 1, wherein the first set and the second set of discrete quantized values combine to generate a combined set of discrete values of the combined radiated luminance having a larger number of discrete quantized values than the sum of discrete quantized values in the first set and the second set.

3. The display panel control apparatus of claim 1 wherein the discrete radiated luminance levels for the first field are different from the discrete radiated luminance levels for the second field for at least one luminance interval.

4. The display panel control apparatus of claim 1 wherein the combinations of the discrete radiated luminance levels for the first field and the discrete radiated luminance levels for the second field are different for at least one luminance interval.

5. The display panel control apparatus of claim 1 wherein the discrete radiated luminance levels for the first field correspond to a non-linear quantization of a radiated luminance from the first pixel.

6. The display panel control apparatus of claim 1 further comprising means (201) for determining discrete quantized values of at least one of the first set and the second set in response to an image characteristic.

7. The display panel control apparatus of claim 6 wherein the image characteristic comprises a luminance distribution characteristic for an area of the image.

8. The display panel control apparatus of claim 1 further comprising means (201) for determining discrete quantized values of at least one of the first set and the second set in response to a display characteristic for the display panel.

9. The display panel control apparatus of claim 8 wherein the display characteristic comprises a response time characteristic.

10. The display panel control apparatus of claim 1 further comprising means (201) for determining discrete quantized values of at least one of the first set and the second set in response to a minimisation of a cost function indicative of a difference between the discrete values of the combined set and a desired radiated luminance distribution.

11. The display panel control apparatus of claim 1 wherein the first drive signal comprises a first pixel drive signal specific to the first pixel and the second drive signal comprises a second pixel drive signal specific to the first pixel, the first driver (107) is arranged to generate the first pixel drive signal as a first function of the image pixel value, and the second driver (109) is arranged to generate the second pixel drive signal as a second function of the image pixel value wherein the first function and the second function are different.

12. The display panel control apparatus of claim 11 wherein the second function is generated by introducing at least one of an offset and a multiplication to the first function.

13. The display panel control apparatus of claim 1 wherein the first drive signal comprises a first pixel drive signal specific to the first pixel and a first common drive signal common to a plurality of pixels, and the second drive signal comprises a second pixel drive signal specific to the first pixel and a second common drive signal common to the plurality of pixels wherein the first common drive signal is different than the second common drive signal.

14. A display system comprising a display panel control apparatus in accordance with claim 1 and the display panel.

15. A method of controlling a display panel (103), the method comprising:
receiving image data for an image to be displayed by the display panel (103) in at least a first field and a second field;
generating a first drive signal for at least a first pixel of the display panel (103) for the first field in response to an image pixel value for the first pixel, the first drive signal having a value selected from a first set of discrete quantized values and corresponding to a first radiated luminance level, each discrete quantized value of the first set corresponding to a discrete radiated luminance level from the display panel (103) for the first field;
generating a second drive signal for the first pixel of the display panel (103) for the second field in response to the image value for the first pixel, the second drive signal having a value selected from a second set of discrete quantized values and corresponding to a second radiated luminance level, each discrete quantized value of the second set corresponding to a discrete radiated luminance level from the display panel (103) for the second field;
wherein the first and second radiated luminance levels are different and have a combined radiated luminance corresponding to a luminance level of the first pixel in the image and the first set and the second set of discrete quantized values combine to generate a combined set of discrete values of the combined radiated luminance having a larger number of discrete quantized values than either of the first set and the second set.
